(19) United States
(12) Patent Application Publication
(10) Pub. No.: US 2005/0032558 A1
(43) Pub. Date: Feb. 10, 2005

(54) Keymat with photocatalyst material and mobile phone having same

(76) Inventor: Ga Lane Chen, Fremont, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/901,622

(22) Filed: Jul. 28, 2004

(30) Foreign Application Priority Data
Aug. 8, 2003 (TW) 92121869

(51) Int. Cl. G03C 5/16

(52) U.S. Cl. 455/575.1; 455/90.3

(57) ABSTRACT

A keymat (50) in accordance with the present invention includes a body portion (520) and a plurality of keys (540) arranged on the body portion. Each keys has a layer of photocatalyst material (560) on an outside thereof.

A mobile phone (3) in accordance with the present invention includes: a main body (30); a cover (40) defining a plurality of through holes (460); and the keymat. The keymat includes the body portion and the plurality of keys formed thereon. Each keys has the layer of photocatalyst material on the outside thereof. The keymat is interposed between the main body and the cover, with the keys extending through corresponding through holes of the cover.

### BACKGROUND OF THE INVENTION

1. Field of the Invention

The present invention relates to a keymat typically used in a mobile phone, and more particularly to a keymat having photocatalyst material therein.

2. Description of Related Art

Almost all commercial mobile phones comprise a plurality of keys which are provided for inputting of commands or information. The keys are operated manually, and may accumulate bacteria and other contaminants thereon. Soiled mobile phones can become sources of infection, irritation and illness.

Photocatalyst materials (such as titanium oxide and oxides of zinc) have been utilized to solve such problems. The operational principles of such materials are explained in detail below, using titanium oxide (TiO₂) as an example of these kinds of photocatalyst materials.

When irradiated by ultraviolet light having a wavelength less than or equal to 380 nanometers, particles of titanium oxide react with adjacent molecules of water and oxygen. A plurality of hydrogen ions (H⁺), hydroxyl ions (OH⁻), and free radicals having strong reductive and oxidative capabilities (such as O⁻, O₂⁻, and O₃⁻) are produced by such reaction. Thus, contaminants on a surface can be decomposed by the free radicals and then removed. In addition, large water droplets can not easily form on the surface, due to the presence of hydrogen ions (H⁺) and hydroxyl ions (OH⁻) thereon. A contact angle between any water droplet and the surface is reduced to a value close to zero, which is significantly less than a corresponding contact angle in the case where no photocatalyst materials are used. That is, the surface is rendered super hydrophilic after irradiation by ultraviolet light.

In summary, after ultraviolet light irradiation, bacteria and contaminants on a soiled surface can be easily removed.

For instance, Taiwan Patent Issue No. 68320 entitled “Method for Arranging Photocatalyst Materials on a Transmitter of a Telephone” discloses a mobile phone which is represented in FIG. 2. Photocatalyst materials are provided on a shell of the phone. The method includes incorporating the photocatalyst materials into raw materials of the shell during a process of forming the shell. Thereby, the photocatalyst materials are uniformly distributed in the shell. As a result, the shell can avoid buildup of bacteria and can be easily cleaned. Nevertheless, the keys of the phone do not incorporate photocatalyst materials and must still be cleaned by conventional means.

### SUMMARY OF THE INVENTION

In view of the above-described shortcomings, a first object of the present invention is to provide a keymat for a mobile phone which is easily cleaned.

A second object of the present invention is to provide a mobile phone having the keymat that is easily cleaned.

In order to achieve the first object set out above, a keymat in accordance with a preferred embodiment of the present invention comprises a body portion and a plurality of keys arranged on the body portion. Each key comprises a layer of photocatalyst material on an outside thereof.

In order to achieve the second object set out above, a mobile phone in accordance with a preferred embodiment of the present invention comprises: a main body; a cover defining a plurality of through holes and a keymat. The keymat comprises a body portion and a plurality of keys formed thereon. Each key comprises a layer of photocatalyst material on an outside thereof. The keymat is interposed between the main body and the cover, with the keys extending through corresponding through holes of the cover.

Because of reactions among photocatalyst material of the photocatalyst layer, water and oxygen under ultraviolet light irradiation, bacteria and contaminants can be thoroughly and easily removed from the keys of the keymat.

These and other features, aspects and advantages of the invention will become more apparent from the following detailed description, claims, and the accompanying drawings.

### BRIEF DESCRIPTION OF THE DRAWINGS

FIG. 1 is an exploded, isometric view of a mobile phone in accordance with the preferred embodiment of the present invention.

FIG. 2 is a front elevational view of a conventional mobile phone.

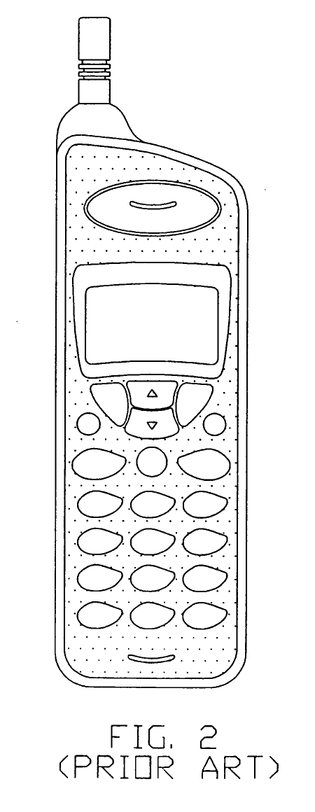

### DETAILED DESCRIPTION OF THE PREFERRED EMBODIMENT OF THE PRESENT INVENTION

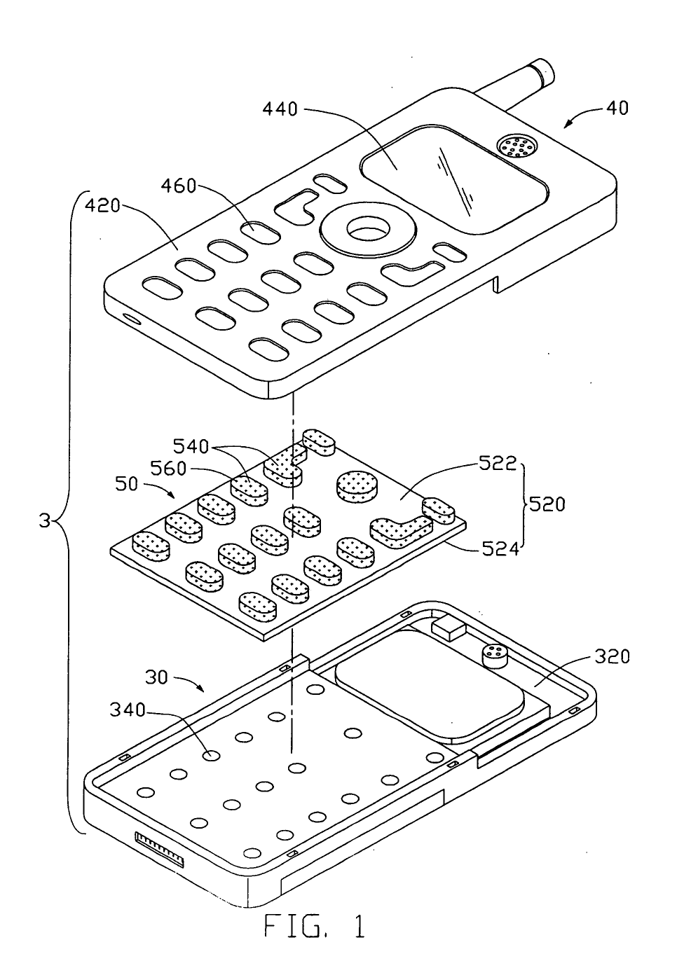

With reference to FIG. 1, there is shown a mobile phone 3 in accordance with a preferred embodiment of the present invention. The mobile phone 3 comprises a main body 30, a cover 40 defining a plurality of keyholes 460, and a keymat 50 having photocatalyst material therein. The keymat 50 comprises a body sheet 520, and a plurality of keys 540 formed on the body sheet 520. In the preferred embodiment, each key 540 is formed with a photocatalyst layer 560 on an outside thereof. When the mobile phone 3 is assembled, the keymat 50 is interposed between the main body 30 and the cover 40. The keys 540 extend through corresponding keyholes 460 of the cover 40.

The main body 30 comprises a circuit board 320, and a plurality of conductive keypoints 340 formed on the circuit board 320. The keypoints 340 are generally made of conductive rubber. Each keypoint 340 corresponds to at least one of working portions (not shown) on the circuit board 320. When a certain key 540 is depressed, an electrical connection is thereby established between the keypoint 340 and one or more corresponding working portions on the circuit board 320. When the key 540 is released, the keypoint 340 disconnects from said working portions and returns to its normal state.

The cover 40 is provided for protecting the main body 30 from external contamination and impact. The cover 40 is contoured to fit on the main body 30. In the preferred embodiment, the cover 40 comprises a shell 420, a display window 440 and a plurality of keyholes 460. The shell 420 is generally constructed of metallic or plastic materials, and is mechanically engaged with the main body 30. The shell 420 defines an opening in which the display window 440 is fitted, the display window 440 corresponding to a display screen (not labeled) of the main body 30. The keyholes 460 are arranged and configured to correspond to a layout and configurations of the keys 540. That is, each keyhole 460 is substantially similar in size and shape to its corresponding key 540. When the cover 40 is attached to the main body 30, the keys 540 of the keymat 50 project out beyond the corresponding keyholes 460.

The keymat 50 of the preferred embodiment comprises the body sheet 520, the keys 540, and the plurality of photocatalyst layers 560 on the keys 540. The body sheet 520 is generally made of rubber or plastic material. The body sheet 520 has a first surface 522 with the keys 540 integrally formed thereon, and a second opposite surface 524 brought into contact with the main body 30. The keys 540 have top contact faces (not labeled) for manual operation. The keys 540 are mostly elliptical with straight sides, and are generally constructed of silicon rubber or plastic. The keys 540 may alternatively be separately formed from the body sheet 520 and then attached to the body sheet 520. The keys 540 can have coatings thereon indicating letters and numbers, or for decoration.

The main feature of the present invention is the keys 540 of the keymat 50 having the photocatalyst layers 560. In the preferred embodiment, the photocatalyst layers 560 are formed on the keys 540 by a spraying or coating process. Alternatively, the keys 540 may be immersed in a photocatalyst containing solution for a period of time in order to form the photocatalyst layers 560. The photocatalyst material can be selected from any one or more of titanium oxide (TiO₂), oxides of zinc (ZnOₓ) and other suitable materials. Sizes of particles of the photocatalyst material are preferably in the range from 15 to 50 nanometers.

In an alternative embodiment, the photocatalyst material may be incorporated in a base material of the keys 540. Thereby, the particles of the photacatalyst material are uniformly distributed in an entirety of the keys 540, instead of merely in photocatalyst layers thereof.

In a further alternative embodiment, the photocatalyst material may be incorporated in a base material of the keys 540 and the body sheet 520. Thereby, particles of the photacatalyst material are uniformly distributed in an entirety of the keymat 50, instead of merely in the keys 540.

In assembly, the cover 40 is mechanically engaged with the main body 30. The keymat 50 is sandwiched between the main body 30 and the cover 40. The first surface 522 of the body sheet 520 is brought into contact with an inner surface of the cover 40. The second surface 524 of the body sheet 520 is in contact with the main body 30. The keys 540 protrude out through the keyholes 460 of the cover 40. The keys 540 can be pressed in order to urge the keypoints 340.

To clean the keymat 50, it is preferably taken out from the mobile phone and subjected to ultraviolet light irradiation for a period of time. The keymat 50 is then wiped and rinsed with clean water. Bacteria and contaminants are thereby readily killed and removed from the keymat 50. Alternatively, the mobile phone 3 with the protruding keys 540 may be exposed to ultraviolet light for a period of time. The keys 540 are then wiped with clean water. Bacteria and contaminants are thereby readily killed and removed from the keys 540.

Moreover, particles containing gold (Au) or platinum (Pt) may be included with the photocatalyst material, in order to enhance decomposition of carbon monoxide.

It should be noted that the above-described mobile phone has been provided for the purposes of illustrating the present invention. Said mobile phone is not critical to practicing the present invention. A variety of conventional mobile phones are known to those skilled in the art, and may be suitably adapted for practicing the present invention. In particular, the keys 540 are exemplified herein for illustration purposes only, and are not intended to limit the present invention.

Further, while the present invention has been described with reference to particular embodiments, the description is illustrative of the invention and is not to be construed as limiting the invention. Therefore, various modifications can be made to the preferred embodiments by those skilled in the art without departing from the true spirit and scope of the invention as defined by the appended claims.

1. A keymat comprising:
a body portion; and
a plurality of keys arranged on the body portion;
wherein at least one of the keys comprises photocatalyst material in at least an outside layer portion thereof.

2. The keymat as claimed in claim 1, wherein, the photocatalyst material comprises a plurality of photocatalyst particles, and sizes of the photocatalyst particles are in the range from 15 to 50 nanometers.

3. The keymat as claimed in claim 1, wherein the photocatalyst material is selected from the group consisting of titanium oxide (TiO₂) and oxides of zinc (ZnOₓ).

4. The keymat as claimed in claim 1, wherein said outside layer portion is formed on said at least one of the keys.

5. The keymat as claimed in claim 1, wherein said outside layer portion is formed on said at least one of the keys by spraying or coating or by immersing said at least one of the keys in a photocatalyst containing solution for a period of time.

6. The keymat as claimed in claim 1, wherein said at least one of the keys comprises photocatalyst material in an entirety thereof.

7. The keymat as claimed in claim 1, wherein the keys are integral with the body portion.

8. The keymat as claimed in claim 7, wherein the body portion and the plurality of keys comprises photocatalyst material in an entirety thereof.

9. A mobile phone comprising:
a main body;
a cover defining a plurality of through holes; and,
a keymat comprising a body portion and a plurality of keys formed thereon;
wherein the keymat is interposed between the main body and the cover, and the keys extend through corresponding through holes of the cover; and at least one of the keys comprises photocatalyst material in at least an outside layer portion thereof.

10. The mobile phone as claimed in claim 9, wherein the photocatalyst material comprises a plurality of photocatalyst particles, and sizes of the photocatalyst particles are in the range from 15 to 50 nanometers.

11. The mobile phone as claimed in claim 9, wherein the photocatalyst material is selected from the group consisting of titanium oxide (TiO₂) and oxides of zinc (ZnOₓ).

12. The mobile phone as claimed in claim 9, wherein said outside layer portion is formed on said at least one of the keys.

13. The mobile phone as claimed in claim 9, wherein said outside layer portion is formed on said at least one of the keys by spraying or coating or by immersing said at least one of the keys in a photocatalyst containing solution for a period of time.

14. The mobile as claimed in claim 9, wherein said at least one of the keys comprises photocatalyst material in an entirety thereof.

15. The mobile as claimed in claim 9, wherein the keys are integral with the body portion.

16. The mobile as claimed in claim 15, wherein the body portion and the plurality of keys comprises photocatalyst material in an entirety thereof.

17. The mobile as claimed in claim 9, wherein the keys are attached on the body portion.

18. The mobile as claimed in claim 9, wherein said at least one of the keys further comprises other material in said at least a outside layer portion thereof, said other material comprising particles containing either or both of gold and platinum.

19. A mobile phone comprising:
a main body;
a cover defining a plurality of through holes; and
a plurality of keys located above the main body and extending upwardly through the corresponding through holes, respectively, and exposed to an exterior above the cover; wherein
the keys comprise photocatalyst material thereon and are exposed to ultraviolet light.
